(19) United States
(12) Patent Application Publication
(10) Pub. No.: US 2021/0254269 A1
(43) Pub. Date: Aug. 19, 2021

(54) CONTROL APPARATUS, VEHICLE, NON-TRANSITORY COMPUTER READABLE MEDIUM, AND CONTROL METHOD

(71) Applicant: TOYOTA JIDOSHA KABUSHIKI KAISHA, Toyota-shi (JP)

(72) Inventors: Hiromitsu FUJII, Kariya-shi (JP); Kohei MIWA, Nisshin-shi (JP); Yuko MIZUNO, Nagoya-shi (JP); Shinsuke ARIGA, Nagoya-shi (JP); Hirotaka OMISHA, Nisshin-shi (JP); Tsuyoshi OKADA, Nagoya-shi (JP)

(73) Assignee: TOYOTA JIDOSHA KABUSHIKI KAISHA, Toyota-shi (JP)

(21) Appl. No.: 17/161,895

(22) Filed: Jan. 29, 2021

(30) Foreign Application Priority Data
Feb. 14, 2020 (JP) 2020-023759

(51) Int. Cl. D06F 95/00; G01C 21/36; G06Q 10/10; G06Q 10/08; G05B 15/02; D06F 33/34

(52) U.S. Cl. CPC D06F 95/00; G01C 21/3617; G06Q 10/1097; D06F 2105/02; G05B 15/02; D06F 33/34; G06Q 10/083

(57) ABSTRACT

A control apparatus includes a controller, and controls a vehicle that is communicatively connected to a user terminal. The controller is configured to perform: control to collect a laundry item at a position designated by a user according to a collection request from the user terminal; control to transport the collected laundry item to a washing place, or to wash the collected laundry item in the vehicle: and, control to deliver the washed laundry item to a delivery destination designated by the user.

### CROSS-REFERENCE TO RELATED APPLICATION

This application claims priority of Japanese Patent Application No. 2020-023759 (filed on Feb. 14, 2020), the entire contents of which are incorporated herein by reference.

### TECHNICAL FIELD

The present disclosure relates to a control apparatus, a vehicle, a program, and a control method.

### BACKGROUND

Navigation apparatuses that propose a travel plan, provide route guidance when the proposed travel plan is selected by a driver, and receive a satisfaction rating from a user after completion of the route guidance are known (for example, Patent Literature [PTL] 1).

### CITATION LIST

### Patent Literature

PTL 1: JP 2009-258026 A

### SUMMARY

Although the navigation apparatus described above proposes a travel plan for a traveler, the navigation apparatus does not execute a process that considers laundry items of the traveler.

It would be helpful to provide a control apparatus, a vehicle, a program, and a control method, which are able to reduce the burden of carrying and washing a laundry item that has been worn by a traveler.

A control apparatus according to an embodiment of the present disclosure includes a controller, the control apparatus being configured to control a vehicle that is communicatively connected to a user terminal, wherein the controller is configured to perform:

control to collect a laundry item at a position designated by a user according to a collection request from the user terminal;

control to transport the collected laundry item to a washing place, or to wash the collected laundry item in the vehicle; and

control to deliver the washed laundry item to a delivery destination designated by the user.

A program according to an embodiment of the present disclosure is configured to cause a computer, as a control apparatus for controlling a vehicle that is communicably connected to a user terminal, to execute:

control to collect a laundry item at a position designated by a user according to a collection request from the user terminal;

control to transport the collected laundry item to a washing place, or to wash the collected laundry item in the vehicle; and

control to deliver the washed laundry item to a delivery destination designated by the user.

A control method according to an embodiment of the present disclosure is performed by a control apparatus configured to control a vehicle that is communicably connected to a user terminal. The control method includes:

controlling to collect a laundry item at a position designated by a user according to a collection request from the user terminal;

controlling to transport the collected laundry item to a washing place, or to wash the collected laundry item in the vehicle; and

controlling to deliver the washed laundry item to a delivery destination designated by the user.

A control apparatus, a vehicle, a program, and a control method according to an embodiment of the present disclosure are able to reduce the burden of carrying and washing a laundry that has been worn by a traveler.

### BRIEF DESCRIPTION OF THE DRAWINGS

In the accompanying drawings:

FIG. 1 is a schematic diagram of an information processing system;

FIG. 2 is a block diagram illustrating a configuration of a control apparatus;

FIG. 3 is a block diagram illustrating a configuration of a vehicle;

FIG. 4 is a block diagram illustrating a configuration of a user terminal;

FIG. 5 illustrates a data structure of a collection database (DB);

FIG. 6 illustrates a data structure of a schedule DB;

FIG. 7 illustrates collection of laundry items;

FIG. 8 illustrates a data structure of a laundry item DB;

FIG. 9 illustrates a data structure of a washing place DB;

FIG. 10 illustrates a delivery of the laundry items; and

FIG. 11 is a flow chart illustrating operation of the control apparatus.

### DETAILED DESCRIPTION

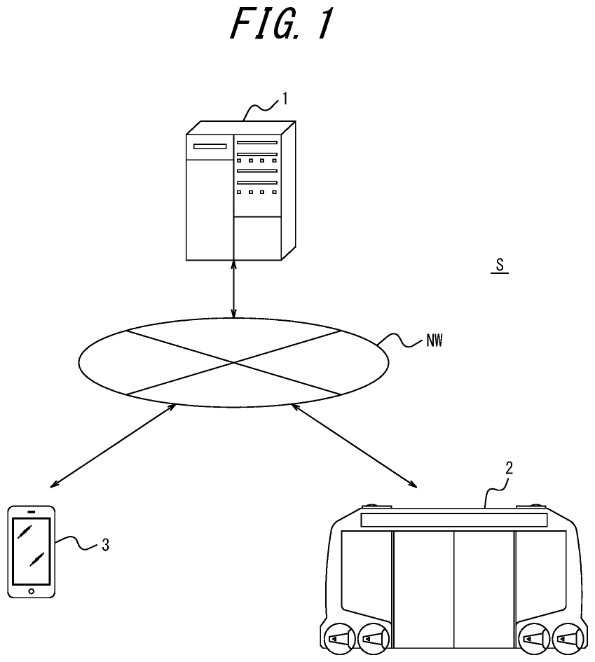

FIG. 1 is a schematic diagram of an information processing system S according to an embodiment. The information processing system S includes a control apparatus 1, a vehicle 2, and a user terminal 3, which are communicably connected to each other. FIG. 1 illustrates one of each of the control apparatus 1, the vehicle 2, and the user terminal 3, for convenience of explanation. However, the number of control apparatuses 1, the number of vehicles 2, and the number of user terminals 3 are not limited to one. The control apparatus 1, the vehicle 2, and the user terminal 3 are connected, for example, via a network NW which includes a mobile communication network and the Internet.

The control apparatus 1 may be a server that assists a provider in providing a vehicle dispatch service. The control apparatus 1 may be, for example, installed in a facility dedicated to a vehicle dispatch provider or in a shared facility including a data center. As an alternative example, the control apparatus 1 may be mounted in the vehicle 2.

The vehicle 2 is controlled by the control apparatus 1. The vehicle 2 includes, for example, any type of automobile such as a gasoline vehicle, a diesel vehicle, an HV, a PHV, an EV, or an FCV. The term “HV” is an abbreviation of Hybrid Vehicle. The term “PHV” is an abbreviation of Plug-in Hybrid Vehicle. The term “EV” is an abbreviation of Electric Vehicle. The term “FCV” is an abbreviation of Fuel Cell Vehicle. Although the driving of the vehicle 2 is automated at any level in the present embodiment, the vehicle 2 may be driven by a driver in another embodiment. The automation level is, for example, any one of Level 1 to Level 5 according to the level classification defined by the SAE. The name “SAE” is an abbreviation of Society of Automotive Engineers. The vehicle 2 may be a MaaS-dedicated vehicle. The term “MaaS” is an abbreviation of Mobility as a Service.

The user terminal 3 is a terminal in the possession of a user. The user terminal 3 may be, for example, a mobile device including a mobile phone, a smartphone, or a tablet, or may be a PC. The term “PC” is an abbreviation of Personal Computer.

An outline of processing that is executed by the control apparatus 1 according to the present embodiment will be described. The control apparatus 1 controls the vehicle 2. The vehicle 2 collects a laundry item at a position designated by a user, according to a collection request from the user terminal 3. The vehicle 2 transports the collected laundry item to a washing place, or washes the collected laundry item in the vehicle 2. The vehicle 2 delivers the washed laundry item to a delivery destination designated by the user. The above configuration enables the control apparatus 1 to collect the laundry item that has been worn by the user at a place away from home (for example, a travel destination), and deliver the laundry item to a delivery destination such as a user's home. Thus, the control apparatus 1 is able to reduce, for a user, the burden of carrying and washing a laundry item that has been worn by the user. Specifically, the control apparatus 1 is able to reduce, for the user, the burden of carrying the laundry items that have been worn by the user, and the burden of washing a lot of laundry items after returning home. In this manner, the control apparatus 1 is able to increase user's satisfaction with respect to travel.

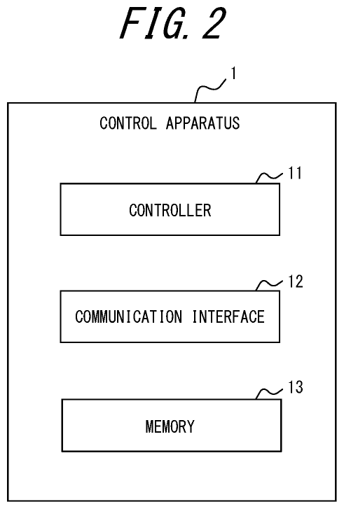

With reference to FIG. 2, an internal configuration of the control apparatus 1 will be described in detail.

The control apparatus 1 includes a controller 11, a communication interface 12, and a memory 13. The components of the control apparatus 1 are communicably connected to one another, for example, via a dedicated line.

The controller 11 includes, for example, one or more general-purpose processors including Central Processing Unit (CPU) or a Micro Processing Unit (MPU). The controller 11 may include one or more dedicated processors that are dedicated to specific processing. The controller 11 may include one or more dedicated circuits instead of the processor. Examples of dedicated circuits may include a Field-Programmable Gate Array (FPGA) and an Application Specific Integrated Circuit (ASIC). As will be described later, the controller 11 of the present embodiment is able to analyze an image of a collected laundry item to determine whether to transport the collected laundry item to a washing place or to wash the laundry item in the vehicle 2.

The communication interface 12 includes, for connecting to the network NW, one or more communication modules that conform to wired or wireless Local Area Network (LAN) standards. The communication interface 12 may include one or more modules conforming to mobile communication standards including the 4th Generation (4G) standard or the 5th Generation (5G) standard. The communication interface 12 may include one or more communication modules conforming to near field communication standards or specifications, including Bluetooth (Bluetooth is a registered trademark in Japan, other countries, or both), AirDrop (AirDrop is a registered trademark in Japan, other countries, or both), IrDA, ZigBee (ZigBee is a registered trademark in Japan, other countries, or both), Felica (Felica is a registered trademark in Japan, other countries, or both), or RFID. The communication interface 12 is configured to transmit and receive any appropriate information via the network NW. The any appropriate information includes, for example, positional information acquired through the Global Positioning System (GPS).

The memory 13 may be, but is not limited to, a semiconductor memory, a magnetic memory, or an optical memory. The memory 13 may function as, for example, a main memory, an auxiliary memory, or a cache memory. The memory 13 may store information resulting from analysis or processing performed by the controller 11. The memory 13 may store various types of information regarding operation and control of the control apparatus 1. The memory 13 may include a system program, an application program, embedded software, and the like. Information stored in the memory 13 of the present embodiment includes information on a collected laundry item. Specifically, the memory 13 includes a collection DB, a schedule DB, a laundry item DB, and a washing place DB. As an alternative example, the collection DB, the schedule DB, the laundry item DB, and the washing place DB may be stored in a storage device external to the control apparatus 1.

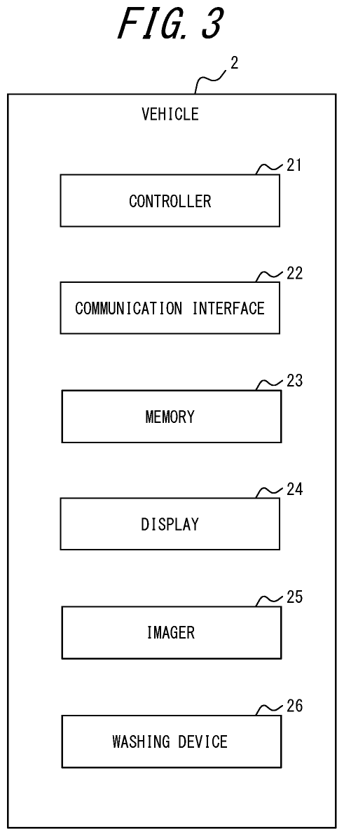

With reference to FIG. 3, an internal configuration of the vehicle 2 will be described in detail.

The vehicle 2 includes a controller 21, a communication interface 22, a memory 23, a display 24, an imager 25, and a washing device 26. The components of the vehicle 2 are communicably connected to one another, for example, via a dedicated line. The hardware components of the controller 21, the communication interface 22, and the memory 23 in the present embodiment are the same as the hardware components of the controller 11, the communication interface 12, and the memory 13 of the control apparatus 1. Therefore, a description thereof is omitted here.

The display 24 is a display interface, and includes, for example, a panel display. The display 24, may display information read from the memory 23, an image captured by the imager 25, or information generated by the controller 21.

The imager 25 includes a camera and is able to capture an image of surroundings. The imager 25 may store the captured image in the memory 23 or transmit the captured image to the controller 21 for the purpose of analysis.

The washing device 26 includes a so-called electric washing machine. The washing device 26 is able to perform at least one of washing, dehydrating, and drying of clothing according to an instruction from the controller 11.

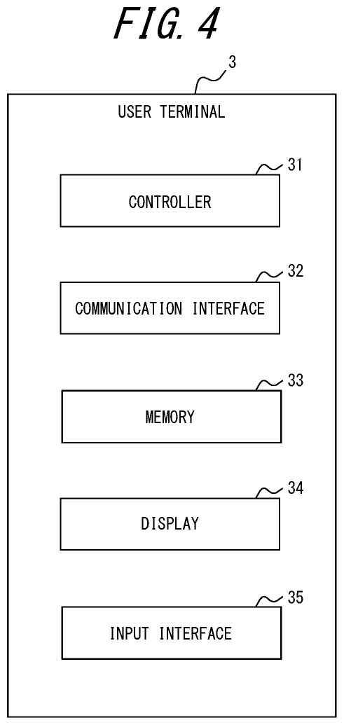

With reference to FIG. 4, an internal configuration of the user terminal 3 will be described in detail.

The user terminal 3 includes a controller 31, a communication interface 32, a memory 33, a display 34, and an input interface 35. The components of the user terminal 3 are communicably connected to one another, for example, via a dedicated line. The hardware components of the controller 31, the communication interface 32, the memory 33, and the display 34 in the present embodiment are the same as the hardware components of the controller 21, the communication interface 22, the memory 23, and the display 24 of the vehicle 2. Therefore, a description thereof is omitted here.

The input interface 35 includes one or more input interfaces that detect a user input and send input information to the controller 31. Examples of input interfaces may include, but are not limited to, a physical key, a capacitive key, a touch screen integrally provided in the panel display, a microphone configured to receive audio input, and an IC card reader.

Hereinafter, processing executed in the information processing system S according to the present embodiment will be described in detail. As an example herein, a user who uses the user terminal 3 is on a trip, and is in possession of clothing that has been worn.

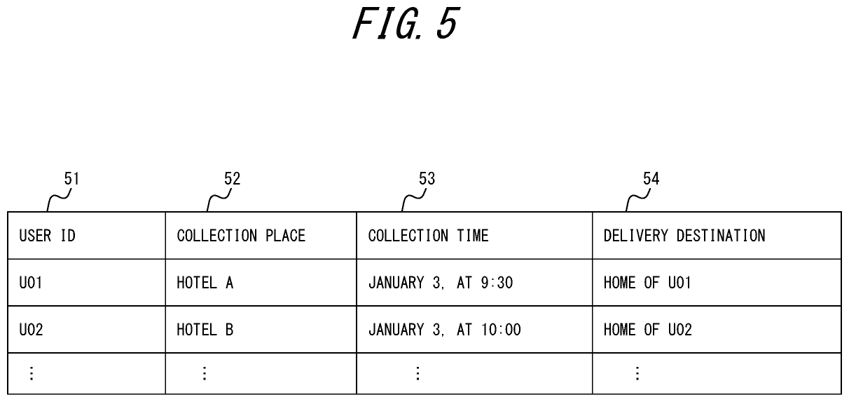

The user operates the user terminal 3 via the input interface 35 in order to request collection of a laundry item that has been worn. The control apparatus 1 receives, from the user terminal 3, a request to collect the laundry item. The control apparatus 1 stores the received collection request in a collection DB in the memory 13, as illustrated in FIG. 5. The collection request includes information on a user ID 51, a collection place 52, a collection time 53, and a delivery destination 54. The user ID 51 is information identifying the user who has made the collection request. The collection place 52 is information on a collection place for the laundry item, which is designated by the user. As an alternative example, the collection place may be information indicating a latitude and a longitude. The collection time 53 is information on a collection time for the laundry item, which is designated by the user. The delivery destination 54 is information indicating a location designated by the user, where the laundry item is to be delivered.

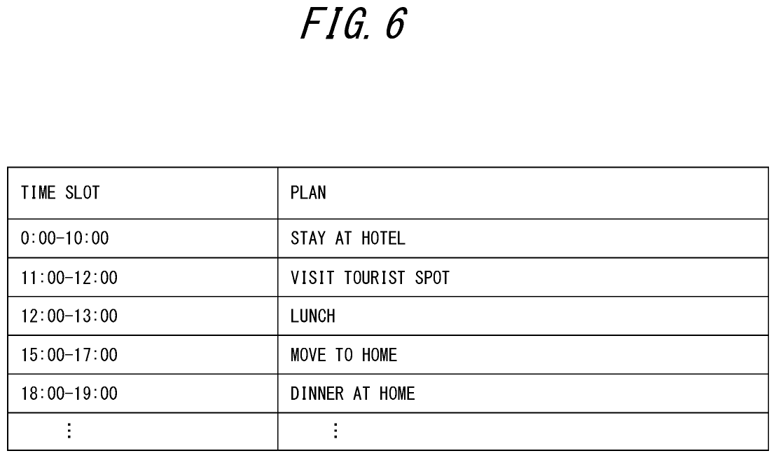

The control apparatus 1 acquires a schedule of the user from a schedule DB in the memory 13. As illustrated in FIG. 6, the schedule of the user includes information on time slots and a plan. The control apparatus 1 determines, according to the schedule, a time slot for delivering the washed laundry item. In the example in FIG. 6, the time at which the user returns home is 17:00. Then, the control apparatus 1 determines to deliver the laundry item to the user's home after 17:00. As an alternative example, the control apparatus 1 may determine to deliver the laundry item at a date and time designated by the user, or may determine to deliver the laundry item when the position of the user terminal 3 matches the position of the user's home, rather than determining a time slot according to the schedule.

When the delivery destination of the laundry item is not designated in the collection request, the control apparatus 1 may determine, according to the schedule of the user, the delivery destination. For example, when the control apparatus 1 determines, from the schedule of the user, that the user is to move to another hotel, the control apparatus 1 may determine to deliver the washed laundry item to the destination hotel.

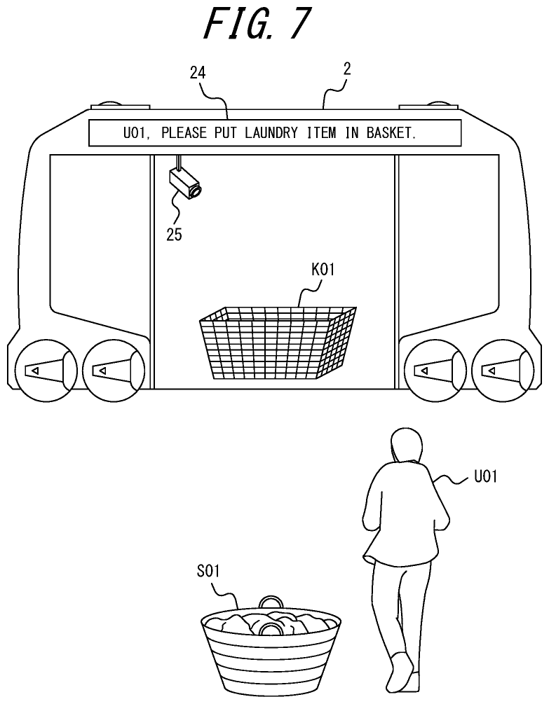

The vehicle 2 moves to the collection place designated by the user. As illustrated in FIG. 7, when the vehicle 2 arrives at the collection place, the vehicle 2 collects one or more laundry items from the user. Specifically, the vehicle 2 opens a door and presents a basket K01, and also displays, via the display 24, an indication that the laundry items are to be placed in the basket K01. The user U01 puts laundry item S01 in their possession into the basket K01.

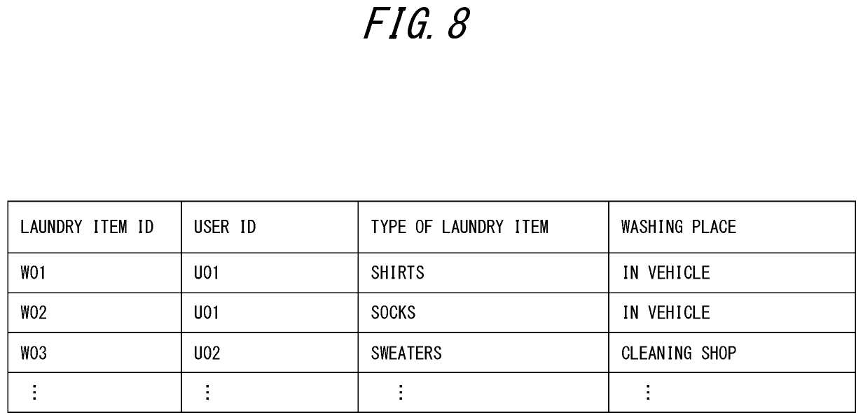

The controller 11 of the control apparatus 1 refers to the collection DB to determine the user ID of the user who has designated a current position of the vehicle 2 as the collection place. Here, the user ID is determined to be U01. The imager 25 of the vehicle 2 captures an image of the laundry item S01 put into the basket K01. The vehicle 2 transmits the captured image to the control apparatus 1 via the communication interface 22. The controller 11 of control apparatus 1 analyzes the received captured image to identify each laundry item by shapes, patterns, colors, or the like. The controller 11 determines, from the result of the identification, a type of the laundry item for each laundry item. As illustrated in FIG. 8, the controller 11 stores, in the laundry item DB in the memory 13, the determined user ID (here, U01) and the type of the laundry item, in association with a laundry ID. In this manner, information on each laundry item is stored in association with each user. The laundry ID is an identification number which is assigned to each laundry item. The types of the laundry items in the present embodiment are “shirts”, “socks”, “sweaters”, or the like. As an alternative example, however, the types of the laundry items may be “for men” or “for women”, or may be “for adults” or “for children”.

The control apparatus 1 determines, according to the type of the laundry item, whether to transport the collected laundry item to a washing place at another location, or to wash the collected laundry item with a washing device 26 in the vehicle 2. For example, as illustrated in FIG. 8, the control apparatus 1 determines that the laundry items W01 and W02, whose types are “shirt” or “socks”, are to be washed in the vehicle 2. The control apparatus 1 sets, in the laundry item DB, the washing places of the laundry items W01 and W02 to “in vehicle”. On the other hand, the control apparatus 1 determines to transport the laundry item W03, of which the type is “sweater”, to a cleaning shop that is one of the washing places. The control apparatus 1 sets, in the laundry item DB, the washing place of the laundry item W03 to “cleaning shop”. As an alternative example, the washing place of the laundry item W03 may be a coin laundry.

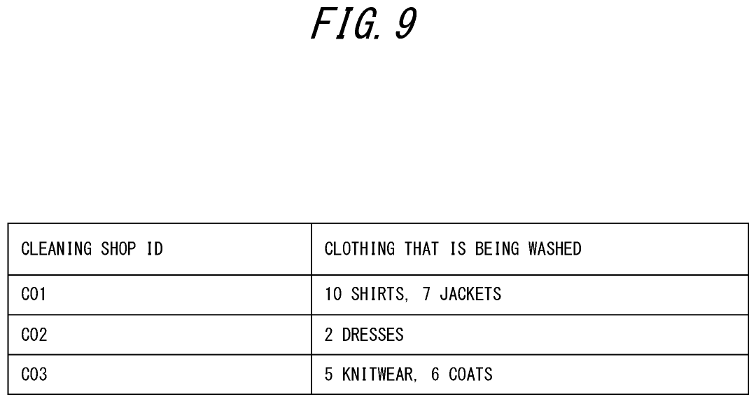

When the control apparatus 1 determines to transport the laundry item to the washing place, the control apparatus 1 extracts candidates of the washing places. The candidates of the washing places may be washing places that are located within a predetermined distance from the position of the vehicle 2. Here, as illustrated in FIG. 9, the candidates are three cleaning shops C01, C02, and C03.

The control apparatus 1 acquires, from the laundry place DB in the memory 13, information on clothing that is being washed at each of the candidates of the washing places. The control apparatus 1 may determine, according to the quantity of laundry items that are being washed at each of the candidates of the washing places, the washing place of a transportation destination. For example, the control apparatus 1 calculates the quantity of laundry items with respect to the cleaning shops C01, C02, and C03, as follows:

Cleaning shop C01: 10 shirts+7 jackets=17 items

Cleaning shop C02: 2 dresses

Cleaning shop C03: 5 knitwear+6 coats=11 items

As an alternative example, the control apparatus 1 may calculate the quantity of laundry items by weight (unit: kilogram), rather than the number of laundry items as described above.

The control apparatus 1 determines the cleaning shop C02, which has the smallest number of laundry items, as the washing place of the transportation destination.

The vehicle 2 moves to the determined washing place. Upon arriving at the washing place, the vehicle 2 unloads the laundry item using a conveyor, a robotic arm, or the like, which is provided in the vehicle 2. As an alternative example, the laundry item may be unloaded by a member of staff at the washing place. The laundry item is washed by a member of staff at the washing place. When washing is completed, the vehicle 2 receives the washed laundry item. The vehicle 2 delivers the received laundry item to the user's home.

On the other hand, when the control apparatus 1 determines to wash the laundry item in the vehicle 2, the control apparatus 1 determines the amount of water to be supplied, based on a water supply place for water to be used in washing, the quantity of the laundry items to be washed in the vehicle 2, and a traveling route of the vehicle 2. In the example here, for convenience of explanation, the location where the vehicle 2 is currently stopped is a location where water can be supplied.

Specifically, the control apparatus 1 identifies the water supply place along the traveling route of the vehicle 2, where the vehicle 2 is to be stopped next. Positional information on the water supply place may be acquired from the memory 13 or from any server connected to the control apparatus 1. The control apparatus 1 sums the quantity of the laundry items currently stored in the vehicle 2, and the quantity of other laundry items that are scheduled to be collected before the vehicle 2 arrives at the next water supply place, to calculate a total value. The quantity of other laundry items that are scheduled to be collected may be estimated from the content of a collection request received from another user terminal 3.

The memory 13 stores, in advance, a correspondence table between the calculated total value and the amount of water required for washing. The control apparatus 1 determines, from the calculated total value, the amount of water required for washing, by referring to the correspondence table. The control apparatus 1 calculates the amount of water that should be supplied at the location where the vehicle 2 is currently stopped, by reducing the amount of water currently stored in the vehicle 2 from the amount of water required for washing. The vehicle 2 supplies the calculated amount of water at the location where the vehicle 2 is currently stopped.

The control apparatus 1 puts the laundry item into the washing device 26, using a conveyor, a robotic arm, or the like, which is provided in the vehicle 2. The washing device 26 in the vehicle 2 washes the laundry item. When the control apparatus 1 determines that washing is completed, the control apparatus 1 controls the vehicle 2 to deliver the washed laundry item to the user's home.

The control apparatus 1 identifies, from locations along the traveling route of the vehicle 2, a drainage place for draining water after completion of washing. After washing is completed, the vehicle 2 drains used water at the identified drainage place.

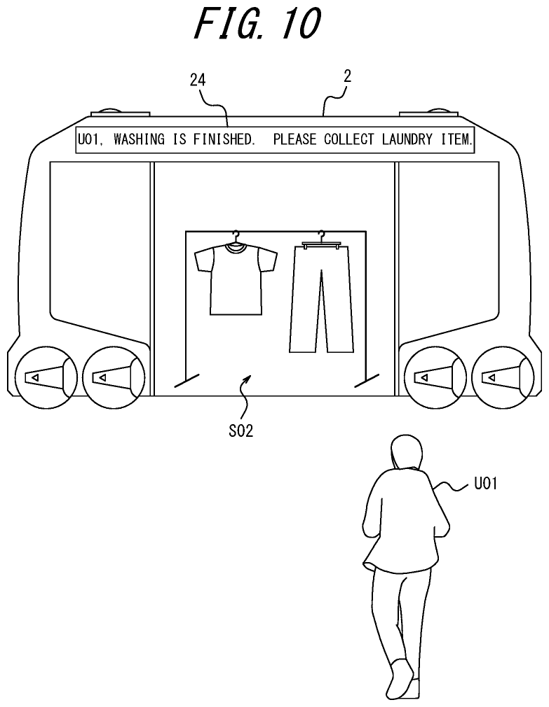

When the vehicle 2 arrives at the user's home, the vehicle 2 opens the door as illustrated in FIG. 10, to present the washed laundry item S02, and also displays, on the display 24, an indication that washing is completed. The user U01 receives the laundry item.

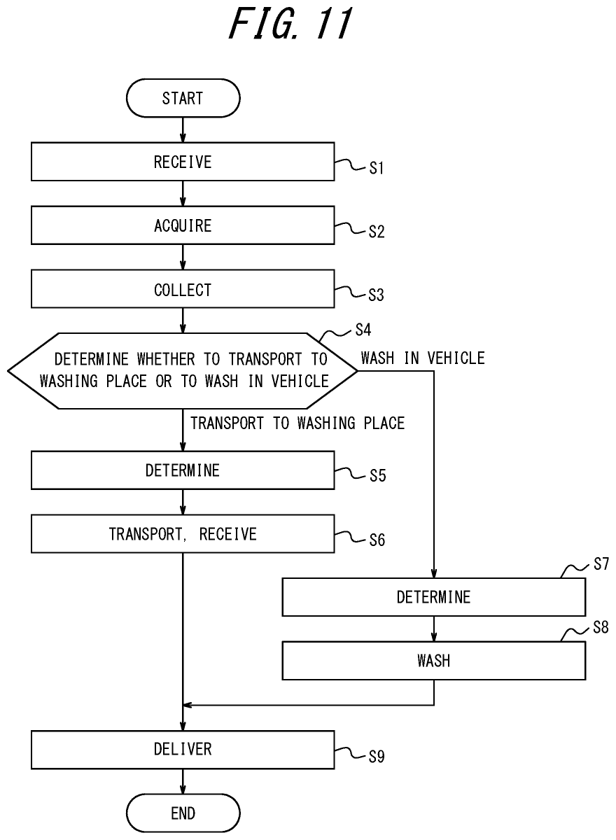

With reference to FIG. 11, a control method executed by the control apparatus 1 will be described.

In Step S1, the control apparatus 1 receives, from the user terminal 3, the collection request for the laundry item.

In Step S2, the control apparatus 1 acquires the schedule of the user of the user terminal 3.

In Step S3, the control apparatus 1 controls the vehicle 2 to collect the laundry item at a position designated by the user in the collection request.

In Step S4, the control apparatus 1 determines whether to transport the collected laundry item to the washing place, or to wash the laundry item in the vehicle 2.

When the control apparatus 1 determines, in Step S4, to transport the collected laundry item to the washing place, the control apparatus 1 determines, in Step S5, to which washing place out of one or more candidates of the washing places the laundry item is to be transported.

In Step S6, the control apparatus 1 controls the vehicle 2 to transport the laundry item to the determined washing place. Further, the control apparatus 1 controls the vehicle 2 to receive the washed laundry item.

On the other hand, when the control apparatus 1 determines, in Step S4, to wash the collected laundry item in the vehicle 2, the control apparatus 1 determines, in Step S7, the water supply amount based on the water supply place for water to be used in washing, the quantity of the collected laundry items, and the traveling route of the vehicle 2.

In Step S8, the control apparatus 1 controls the vehicle 2 to supply water and washes the laundry item with the washing device 26.

In Step S9, the control apparatus 1 controls the vehicle 2 to deliver the washed laundry item to a designated delivery destination.

As described above, according to the present embodiment, the control apparatus 1 controls the vehicle 2. The vehicle 2 collects a laundry item at a position designated by a user, according to a collection request from the user terminal 3. The vehicle 2 transports the collected laundry item to a washing place or washes the collected laundry item in the vehicle 2. The vehicle 2 delivers the washed laundry item to a delivery destination designated by the user. This configuration enables the control apparatus 1 to collect a laundry item that has been worn by the user at a travel destination, and deliver the laundry item to a delivery destination, such as the user's home. Thus, the control apparatus 1 is able to reduce, for the user, the burden of carrying the laundry item that has been worn by the user, and the burden of washing a lot of laundry items after returning home, thereby increasing the user's satisfaction with respect to travel.

According to the present embodiment, the controller 11 of the control apparatus 1 stores, in the memory 13, a type of the collected laundry item. The controller 11 determines, according to the type of the laundry item, whether to transport the collected laundry item to the washing place, or to wash the collected laundry item in the vehicle 2. This configuration enables the control apparatus 1 to finely determine, according to the type of laundry item, a washing method, thereby increasing the user's satisfaction.

According to the present embodiment, when a plurality of laundry items are collected from a plurality of users, the controller 11 stores information on each laundry item in the memory 13 in association with each user, and performs control to deliver each washed laundry item to a position designated by each user. This configuration enables the control apparatus 1 to collect a plurality of laundry items from a plurality of users, and, in this case, to reliably deliver each laundry item to each user.

According to the present embodiment, the controller 11 acquires a schedule of the user, and determines, according to the schedule, a delivery destination. This configuration enables the control apparatus 1 to flexibly adjust the delivery destination. Thus, the control apparatus 1 is able to quickly deliver the laundry item to the user after washing is completed.

According to the present embodiment, the controller 11 acquires the schedule of the user, and determines, according to the schedule, a time slot for delivering the washed laundry item. This configuration enables the control apparatus 1 to, for example, deliver the laundry item to the user's home while avoiding the time period in which the user is absent from the home, thereby reliably delivering the laundry item to the user.

According to the present embodiment, when the controller 11 determines to transport the collected laundry item to the washing place, the controller 11 determines, according to the quantity of laundry items that are being washed at each of a plurality of candidates of the washing places, the washing place of a transportation destination. This configuration enables the control apparatus 1 to avoid requesting washing to a washing place where a relatively large quantity of laundry items are being washed, thereby distributing load on the washing place, and cause washing to be completed quickly.

According to the present embodiment, when the controller 11 determines to wash a collected laundry item in the vehicle 2, the controller 11 determines a water supply amount based on a water supply place for water to be used in washing, the quantity of the laundry items to be washed in the vehicle 2, and a traveling route of the vehicle 2. This configuration enables the control apparatus 1 to avoid a water shortage during washing, thereby causing washing to be reliably completed. This configuration also enables the control apparatus 1 to determine an appropriate amount of water, thus avoiding transporting more water than needed to the vehicle 2. Thus, the control apparatus 1 is able to reduce the energy, such as electricity, that is consumed in the vehicle.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each means or each step can be rearranged without logical inconsistency, and a plurality of means or steps can be combined together or divided.

For example, in the above embodiment, a program that executes all or part of the functions or processing of the control apparatus 1 may be recorded on a computer-readable recording medium. The computer-readable recording medium includes a non-transitory computer-readable medium and may be a magnetic recording apparatus, an optical disc, a magneto-optical recording medium, or a semiconductor memory. The program is distributed, for example, by selling, transferring, or lending a portable recording medium such as a Digital Versatile Disc (DVD) or a Compact Disc Read Only Memory (CD-ROM) on which the program is recorded. The program may also be distributed by storing the program in a storage of the server and transmitting the program from the server to another computer. The program may also be provided as a program product. The present disclosure may also be implemented as a program that can be executed by a processor.

1. A control apparatus comprising a controller, the control apparatus being configured to control a vehicle that is communicatively connected to a user terminal, wherein the controller is configured to perform:
control to collect a laundry item at a position designated by a user according to a collection request from the user terminal;
control to transport the collected laundry item to a washing place, or to wash the collected laundry item in the vehicle; and
control to deliver the washed laundry item to a delivery destination designated by the user.

2. The control apparatus according to claim 1, further comprising a memory, wherein the controller is configured to store a type of the collected laundry item in the memory.

3. The control apparatus according to claim 2, wherein the controller is configured to determine, according to the type of the laundry item, whether to transport the collected laundry item to the washing place, or to wash the collected laundry item in the vehicle.

4. The control apparatus according to claim 1, wherein, when a plurality of laundry items are collected from a plurality of users, the controller performs control to deliver each washed laundry item to a position designated by each user.

5. The control apparatus according to claim 1, wherein the controller is configured to acquire a schedule of the user, and determine, according to the schedule, the delivery destination.

6. The control apparatus according to claim 1, wherein the controller is configured to acquire a schedule of the user, and determine, according to the schedule, a time slot for delivering the washed laundry item.

7. The control apparatus according to claim 1, wherein the controller, upon determining to transport the collected laundry item to the washing place, determines, as the washing place, a transportation destination washing place from among a plurality of candidates for the transportation washing place, according to the quantity of laundry items that are being washed at each of the plurality of candidates.

8. The control apparatus according to claim 1, wherein the controller, upon determining to wash the collected laundry item in the vehicle, determines a water supply amount, based on a water supply place for water to be used in washing, the quantity of the laundry items to be washed in the vehicle, and a traveling route of the vehicle.

9. A vehicle equipped with the control apparatus according to claim 1.

10. A non-transitory computer-readable medium storing a program configured to cause a computer, as a control apparatus for controlling a vehicle that is communicably connected to a user terminal, to execute:
control to collect a laundry item at a position designated by a user according to a collection request from the user terminal;
control to transport the collected laundry item to a washing place, or to wash the collected laundry item in the vehicle; and
control to deliver the washed laundry item to a delivery destination designated by the user.

11. The non-transitory computer-readable medium according to claim 10, wherein the control apparatus comprises a memory, and the program is further configured to cause the computer to execute an operation to store a type of the collected laundry item in the memory.

12. The non-transitory computer-readable medium according to claim 11, wherein the program is further configured to cause the computer to execute an operation to determine, according to the type of the laundry item, whether to transport the collected laundry item to the washing place, or to wash the collected laundry item in the vehicle.

13. The non-transitory computer-readable medium according to claim 10, wherein the program is further configured to cause the computer to, upon collection of a plurality of laundry items from a plurality of users, execute control to deliver each washed laundry item to a position designated by each user.

14. The non-transitory computer-readable medium according to claim 10, wherein the program is further configured to cause the computer to execute an operation to acquire a schedule of the user, and determine, according to the schedule, the delivery destination.

15. The non-transitory computer-readable medium according to claim 10, wherein the program is further configured to cause the computer to execute an operation to acquire a schedule of the user, and determine, according to the schedule, a time slot for delivering the washed laundry item.

16. A control method performed by a control apparatus configured to control a vehicle that is communicably connected to a user terminal, the control method comprising:
controlling to collect a laundry item at a position designated by a user according to a collection request from the user terminal;
controlling to transport the collected laundry item to a washing place, or to wash the collected laundry item in the vehicle; and
controlling to deliver the washed laundry item to a delivery destination designated by the user.

17. The control method according to claim 16, wherein the control apparatus comprises a memory, and the control method further comprises storing a type of the collected laundry item in the memory.

18. The control method according to claim 17, wherein the control method further comprises determining, according to the type of the laundry item, whether to transport the collected laundry item to the washing place, or to wash the collected laundry item in the vehicle.

19. The control method according to claim 16, wherein the control method further comprises, upon collection of a plurality of laundry items from a plurality of users, controlling to deliver each washed laundry item to a position designated by each user.

20. The control method according to claim 16, wherein the control method further comprises, acquiring a schedule of the user, and determining, according to the schedule, the delivery destination.
